(19) United States
(12) Patent Application Publication
(10) Pub. No.: US 2011/0129281 A1
(43) Pub. Date: Jun. 2, 2011

(54) RECORDING DEVICE AND RECORDING MEDIUM SUPPLY MECHANISM FOR A RECORDING DEVICE

(75) Inventor: Masayuki Kumazaki, Matsumoto-shi (JP)

(73) Assignee: SEIKO EPSON CORPORATION, Tokyo (JP)

(21) Appl. No.: 12/954,566

(22) Filed: Nov. 24, 2010

(30) Foreign Application Priority Data
Nov. 27, 2009 (JP) 2009-269397

(51) Int. Cl. B41J 15/04

(52) U.S. Cl. 400/619

(57) ABSTRACT

A recording device and a recording medium supply mechanism for a recording device enable using both fanfold paper and roll paper as recording media. A printer assembly 4 has a print head 43. A fanfold paper supply unit 6 has a upper paper guide 45 and lower paper guide 47 that form at least part of the transportation path that guides the recording medium to the print head 43 side, and a tractor units 60 that supplies fanfold paper 120 with marginal punch holes to the transportation path. A roll paper holder 2 supports a paper roll 110, which is recording paper 112 that is conveyed through the transportation path and is stored wound in a roll. The roll paper holder 2 is disposed above the fanfold paper supply unit 6, which is located behind the printer assembly 4.

### BACKGROUND

1. Technical Field

The present invention relates to recording device and to a recording medium supply mechanism for a recording device.

2. Related Art

Some recording devices that use continuous paper such as fanfold paper as the recording medium use a tractor to feed the paper. See, for example, Japanese Unexamined Patent Appl. Pub. JP-A-H09-226959.

Recording devices that record on continuous paper may also use a dot impact head, a thermal transfer head, or an inkjet head, for example, to record on the paper. Recording devices that can record on roll paper as well as fanfold paper using such recording methods, or can use various types of recording media, are also needed.

However, while fanfold paper is typically lifted and supplied from a stack of folded paper resting on the floor, for example, when roll paper is used the roll into which the paper is wound is typically stored inside the recording device. Furthermore, while fanfold paper is fed by a tractor using marginal punch holes, most roll paper must be fed without using marginal punch holes. Achieving a recording device that can use both fanfold paper and roll paper is therefore difficult because the methods in which the unprinted paper is stored and conveyed are completely different.

### SUMMARY

A recording device and a recording medium supply mechanism for a recording device according to the present invention enable using both fanfold paper and roll paper as a recording medium.

A first aspect of the invention is a recording device including a recording device assembly including a recording head; a sheet guide that forms at least part of a transportation path that guides a recording medium to the recording head side; a continuous sheet media supply unit including a tractor unit that supplies a first recording medium of continuous sheets with marginal punch holes to the transportation path; and a roll media support unit that supports a rolled recording medium, which is a second recording medium that is wound in a roll and is conveyed through the transportation path, the roll media support unit being disposed above the continuous sheet media supply unit disposed at the back side of the recording device assembly.

By disposing a continuous sheet media supply unit having a tractor unit that supplies a first recording medium of continuous sheets with marginal punch holes behind the recording device assembly, and disposing a roll media support unit that supports a rolled recording medium, which is a second recording medium that is wound in a roll, above the continuous sheet media supply unit, both a first recording medium of continuous sheet media and a second recording medium that is wound in a roll can be used, and a compact recording device with a small footprint can be provided.

A recording device according to another aspect of the invention the roll media support unit has an exit unit that limits movement of the second recording medium in the thickness direction to a specific range, and is opposite an entrance to the transportation path when the roll media support unit is installed to the recording device assembly.

This aspect of the invention can guide the second recording medium wound in a roll smoothly to the entrance to the transportation path because the exit unit of the roll media support unit is disposed opposite the entrance to the transportation path, and the exit unit limits movement of the second recording medium to a specific range in the thickness direction.

Further preferably in a recording device according to another aspect of the invention, the roll media support unit has a guide surface that guides a side edge of the second recording medium supplied from the rolled recording medium; the side ends of the exit unit are rendered by a pair of slotted openings that limit sideways movement of the second recording medium; and the side edge of the second recording medium contacts the guide surface from the rolled recording medium to the opening of the exit unit.

Because the second recording medium that is wound in a roll is guided in contact with the guide surface to the exit of the roll media support unit, and passes through a pair of slotted openings that limit movement of the second recording medium widthwise to the entrance to the transportation path in this aspect of the invention, the rolled second recording medium can be conveyed more stably and reliably in a straight line.

Yet further preferably in a recording device according to another aspect of the invention, an engaging claw is disposed to the front part of the roll media support unit; the engaging claw is engaged in an engaging channel that opens to the back of the recording device assembly; and rear feet of the roll media support unit are placed on a flat surface of the main case that houses the recording device assembly.

With this aspect of the invention the roll media support unit is supported so that it will not shift horizontally as a result of engaging claws being engaged in an engaging channel rendered behind the recording device assembly, and the load of the roll media support unit is supported by the main case because the roll media support unit is placed on a flat surface of the main case that houses the recording device assembly. As a result, the second recording medium can be supported stably so that the rolled second recording medium does not interfere with supplying the first recording medium of continuous sheets, and either the second recording medium or the first recording medium can be guided to the entrance of the transportation path.

In a recording device according to another aspect of the invention, the roll media support unit includes a support shaft that supports the second recording medium, and a cover that covers the second recording medium and can open to the back; and a bearing surface that receives a moment that is produced when the cover opens to the back is rendered on the engaging channel that opens to the back of the recording device assembly.

In this aspect of the invention the roll media support unit supports the second recording medium on a support shaft and has a cover that covers the second recording medium supported on this support shaft, and receives the moment that works when the cover opens to the back on a bearing surface of the engaging channel in which an engaging claw at the front of the roll media support unit is engaged. As a result, the rolled recording medium can be supported above the tractor unit while soiling the recording medium can be suppressed by covering the rolled recording medium with a cover that is disposed to not interfere with media transportation.

Yet further preferably in a recording device according to another aspect of the invention, the support shaft of the roll media support unit is located in front of the rear feet.

In this aspect of the invention the load of the rolled second recording medium is dispersed and supported from below by a flat surface of the main case and an engaging channel engaged by an engaging claw at the front of the roll media support unit. The moment produced by the load of the second recording medium wound in a roll does not act on the engaging channel. As a result, because the moment of the load of the second recording medium and the moment that works when the cover opens do not act on the engaging channel in the same direction, load concentration on the engaging channel can be prevented and durability can be improved.

Another aspect of the invention is a recording medium supply mechanism of a recording device that has a recording head, including: a continuous sheet media supply unit including a tractor unit that supplies a first recording medium of continuous sheets with marginal punch holes to a transportation path that guides a recording medium to the recording head side; and a roll media support unit that supports a rolled recording medium, which is a second recording medium that is wound in a roll and is conveyed through the transportation path, and is removably installed to the recording device assembly, the roll media support unit being disposed above the continuous sheet media supply unit disposed at the back side of the recording device assembly.

By disposing a continuous sheet media supply unit having a tractor unit that supplies a first recording medium of continuous sheets with marginal punch holes behind the recording device assembly, and disposing a roll media support unit that supports a rolled recording medium, which is a second recording medium that is wound in a roll, above the continuous sheet media supply unit, both a first recording medium of continuous sheet media and a second recording medium that is wound in a roll can be used, and a compact recording device with a small footprint can be provided.

### EFFECT OF THE INVENTION

The invention provides a compact recording device with a small footprint that can use both a recording medium of continuous sheets and a recording medium that is wound in a roll.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is an external oblique view of a printer according to a preferred embodiment of the invention.

FIG. 2 is an oblique view of the printer with the top cover removed.

FIG. 3 is a side section view of the printer.

FIG. 4 is an external oblique view of the printer with the roll paper holder removed.

FIG. 5 is an oblique view showing roll paper loaded in the roll paper holder.

FIG. 6 is an oblique view of the roll paper holder.

FIG. 7 is an oblique view of the roll paper holder.

FIG. 8 is an oblique view of the roll paper holder from below.

FIG. 9 is a partially cut-away side view showing the roll paper holder when installed.

FIG. 10 is an oblique view of the printer with the separator installed.

FIG. 11 is an oblique view of the printer with the separator slid out.

FIG. 12 is another oblique view of the printer with the separator slid out.

### DESCRIPTION OF EMBODIMENTS

A preferred embodiment of the present invention is described below with reference to the accompanying figures.

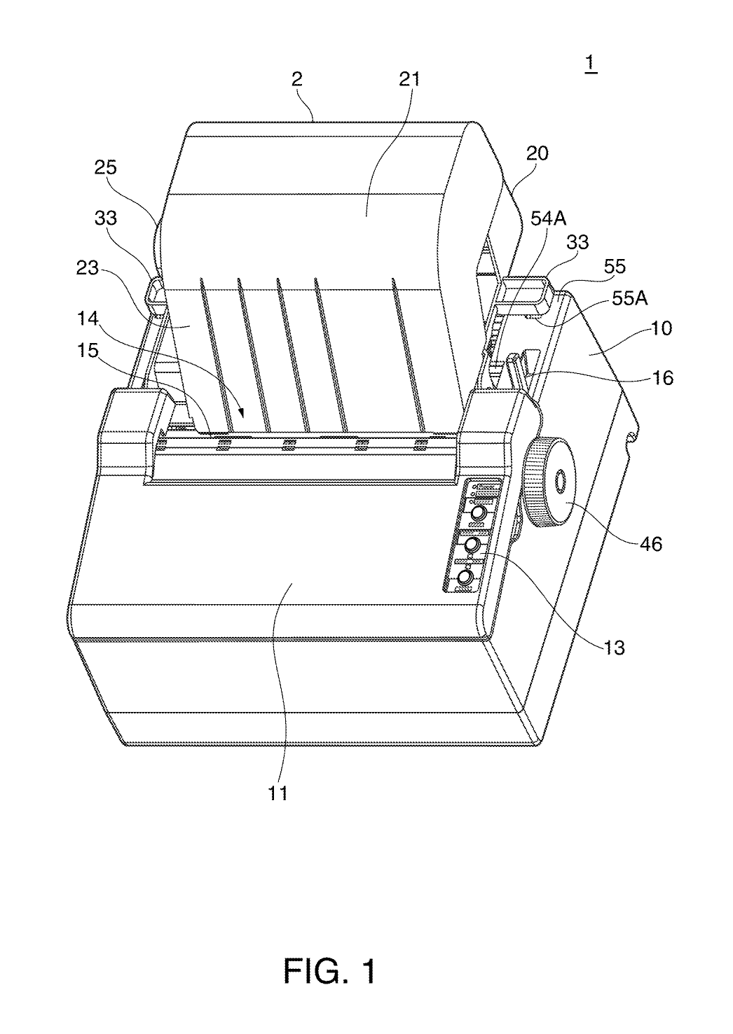

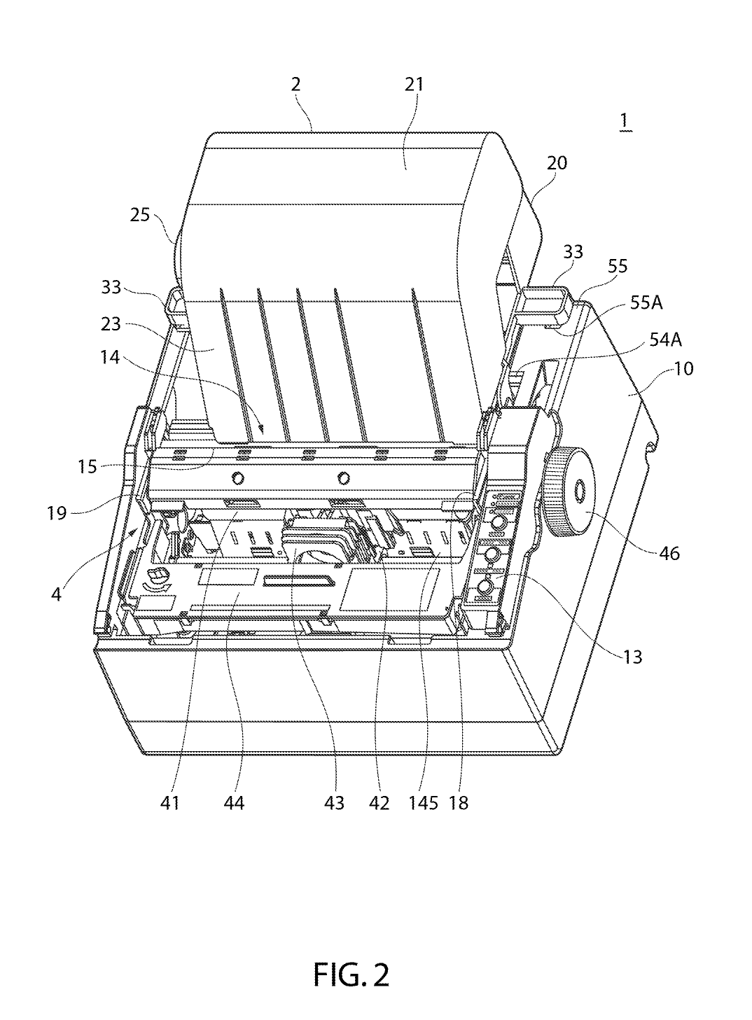

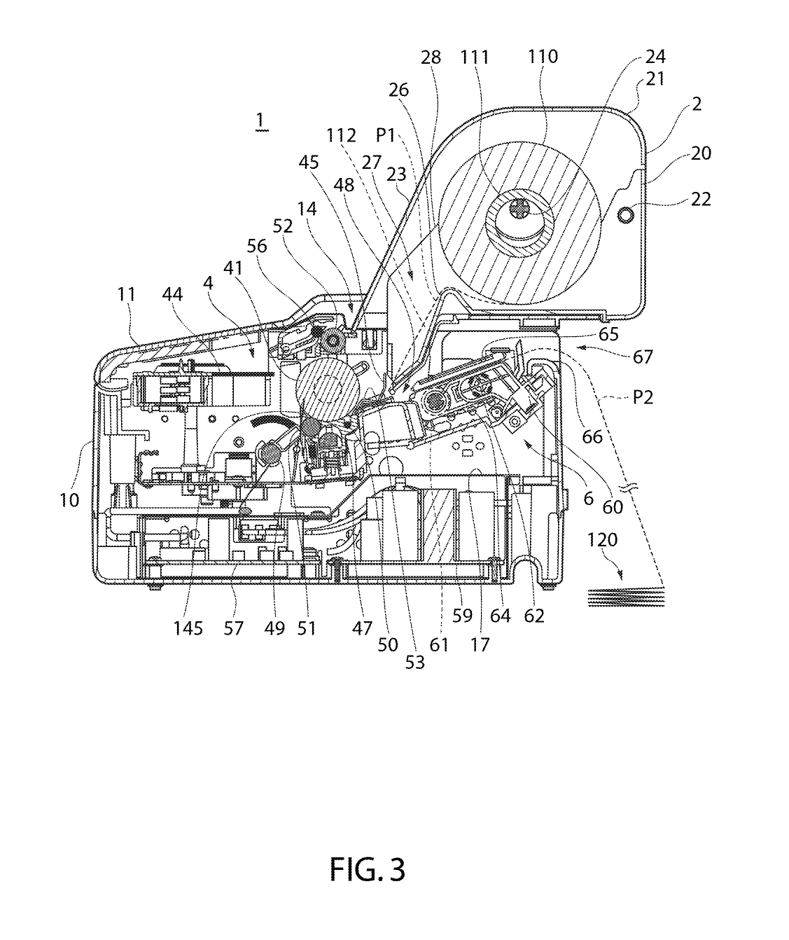

FIG. 1 is an oblique view of a printer 1 according to a preferred embodiment of the invention, FIG. 2 is an oblique view of the printer 1 with the top cover 11 of the main case 10 removed, and FIG. 3 is a side section view of the printer 1. FIG. 3 shows the transportation path P1 of recording paper 112 supplied from a roll paper holder 2, and the transportation path P2 of continuous paper 120 supplied by a fanfold paper supply unit 6.

The printer 1 has a main case 10 and a roll paper holder 2 (roll media support unit) that is attached to the main case 10, and is a recording device that can print text and images on roll paper 112 (second recording medium) that is fed from a paper roll 110 stored in the roll paper holder 2, and on fanfold paper 120 (first recording medium) supplied from behind the main case 10. The printer 1 in this embodiment of the invention is a dot matrix printer that affixes ink to and forms dots on the fanfold paper 120 or roll paper 112 by causing recording wires to protrude. The roll paper 112 is a continuous web of plain paper, for example, that is wound into a paper roll 110 (rolled recording medium) and set in the roll paper holder 2. The fanfold paper 120 is a continuous web of folded form paper, and may be a single or multipart form. The fanfold paper 120 is stored outside the printer 1 and in the example shown in FIG. 3 is stored below the printer 1, and is fed into the printer 1 by the operation of a fanfold paper supply unit 6 (continuous sheet media supply unit) described below.

Either roll paper 112 or fanfold paper 120 can be selected for printing with this printer 1, and either roll paper 112 or fanfold paper 120 can be selected for printing by the operation described below.

The roll paper 112 or fanfold paper 120 (collectively referred to below as the recording medium) is discharged upward from a paper exit 14 rendered near the front end of the roll paper holder 2, and the discharged medium is supported by a discharge guide 23 formed at the front of the roll paper holder 2. A sawtooth cutter 15 for cutting the discharged recording medium is disposed to the paper exit 14.

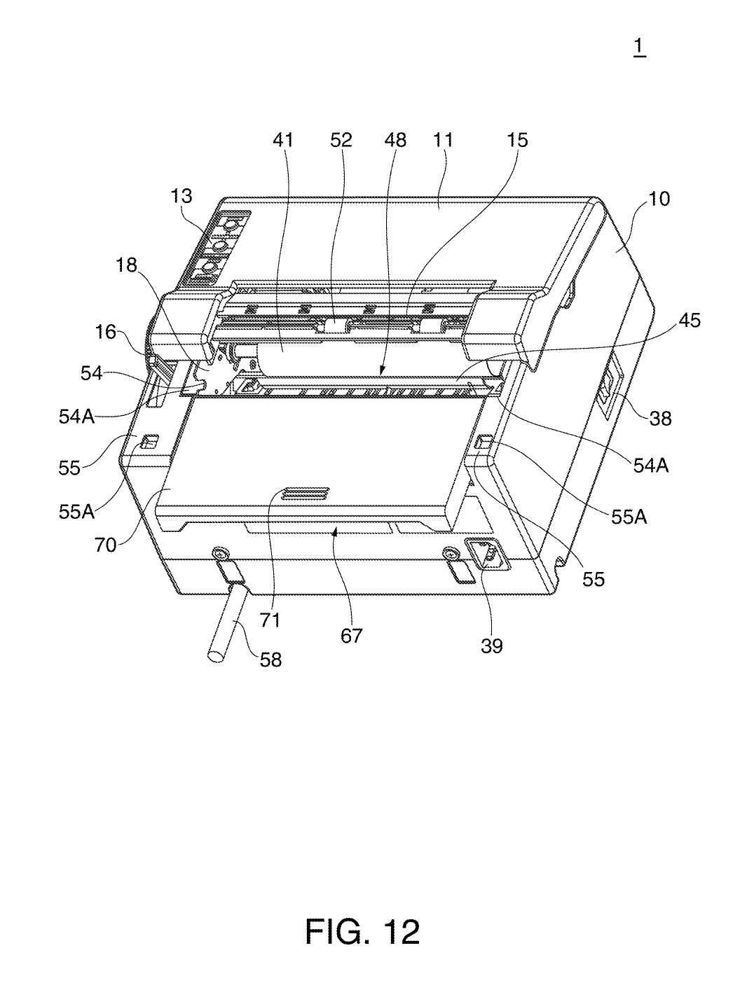

A display and operating unit 13 including switches for operations such as setting and resetting printer 1 operations, and LEDs for displaying the operating status of the printer 1, is disposed in the top of the main case 10. A power switch 38 (see FIG. 12) for turning the printer 1 power on and off is disposed to the left side of the main case 10.

The printer assembly 4 including a print head 43 is housed inside the main case 10, and the printer assembly 4 can be accessed by opening the top cover 11, which is removably disposed to the top of the main case 10. The printer assembly 4 (recording device assembly) is rendered by attaching various parts to a frame that includes a base frame 17 located at the bottom of the frame, and a pair of left and right side frames 18 and 19 fastened to the base frame 17. A platen 41, carriage guide shaft 49, pressure roller 50, follower roller 51, discharge roller 52, discharge assist roller 56, tractor drive shaft 61, and tractor guide shaft 62 are disposed between the right side frame 18 and the left side frame 19. The platen 41 and the tractor drive shaft 61 are driven rotationally by a paper feed motor (not shown in the figure) attached to the right side frame 18.

A carriage 42 that travels bidirectionally on the carriage guide shaft 49 is disposed in front of the roll-shaped platen 41, and the print head 43 from which wires (not shown in the figure) are driven to protrude is disposed to the carriage 42 opposite the platen 41.

A stationary ink ribbon cartridge 44 supported by the right side frame 18 and left side frame 19 is disposed to the printer assembly 4. A ribbon guide is disposed to the carriage 42 between the distal end of the print head 43 and the platen 41, and an ink ribbon (not shown in the figure) that is pulled from the ink ribbon cartridge 44 passes through this ribbon guide.

An elastomer that absorbs the impact of the wires of the print head 43 is disposed to the side of the platen 41, and numerous dots forming text or images are formed on the printing surface of the recording medium by driving the wires of the print head 43 to the elastomer coating of the platen 41 with the ink ribbon and recording medium therebetween.

The platen 41 is driven rotationally by drive power from the transportation motor (not shown in the figure). A lower paper guide 47 with a curved surface that follows the side of the platen 41 is disposed below the platen 41, an upper paper guide 45 is disposed upstream from this lower paper guide 47, and the lower paper guide 47 and upper paper guide 45 together render a paper entrance 48 (entrance) through which roll paper 112 supplied from the roll paper holder 2 and fanfold paper 120 supplied from the fanfold paper supply unit 6 enter the printer assembly 4.

This paper entrance 48 is the entrance to the transportation path (paper feed path) through which the roll paper 112 and fanfold paper 120 are conveyed in the printer assembly 4. Note that in the configuration shown in FIG. 3 the upper paper guide 45 and lower paper guide 47 are rendered separately one above the other, but the upper paper guide 45 and lower paper guide 47 may be rendered in unison to form the transportation path. Note, further, that the upper paper guide 45 and lower paper guide 47 are comparable to a sheet guide.

A switch-type paper detector 53 that detects the advance of roll paper 112 or fanfold paper 120 is disposed to the paper entrance 48 side end of the lower paper guide 47, and a control circuit board 57 described below controls operation of the printer 1 based on the output from the paper detector 53.

A pressure roller 50 is disposed opposite the platen 41 at the paper entrance 48. The recording medium is held and conveyed by the pressure roller 50 and platen 41 between the curved surface of the lower paper guide 47 and the platen 41. The pressure roller 50 is urged toward the platen 41 so that recording media of various thicknesses can be held reliably between the pressure roller 50 and the platen 41.

The follower roller 51 that rotates with the platen 41 as a result of the drive power from the transportation motor (not shown in the figure) is disposed to the lower paper guide 47, and the recording medium is held between this follower roller 51 and the platen 41 and conveyed toward the print head 43.

The recording medium, which is conveyed wrapping partially around the platen 41, is pressed to the side of the platen 41 by a paper presser 145 before the carriage 42. The paper presser 145 presses the recording medium to the platen 41 and prevents the recording medium from lifting away from the platen 41 at the printing position. The recording medium on which the print head 43 prints is conveyed upward by the platen 41, is held between and conveyed upward by the discharge roller 52 disposed above the platen 41 and the discharge assist roller 56 disposed opposite the discharge roller 52, and is discharged from the paper exit 14. The discharge assist roller 56 is urged to the discharge roller 52 so that recording media of various thicknesses can be held between the discharge assist roller 56 and the discharge roller 52. The recording medium exits upward from the paper exit 14 and is conveyed along the discharge guide 23 by the discharge roller 52 and discharge assist roller 56.

The shaft of the platen 41 is connected to a paper feed knob 46 disposed outside the main case 10, and by manually turning the paper feed knob 46 the platen 41 rotates and the recording medium can be fed forward or in reverse.

The control circuit board 57, which controls various parts of the printer 1, and a power supply circuit board 59 are stored in the bottom part of the printer assembly 4. The power supply circuit board 59 turns on and off according to the operation of the power switch 38 (see FIG. 12), and supplies DC power to the control circuit board 57 from an AC power source supplied through a power supply connector 39 (see FIG. 12) disposed in the back of the main case 10.

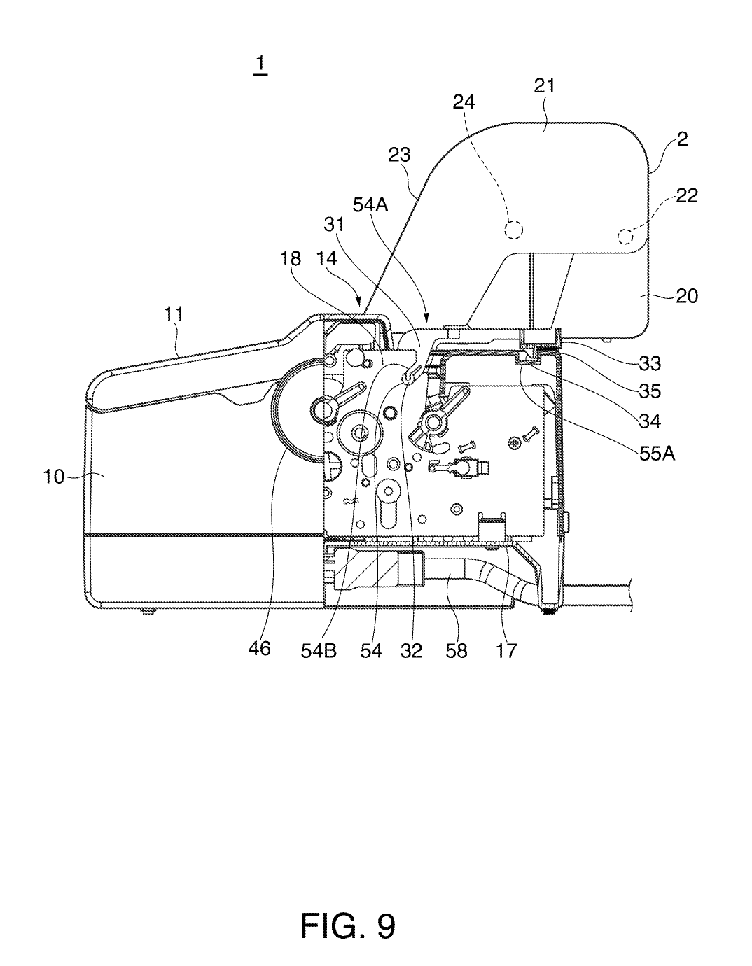

The control circuit board 57 is connected to a host computer or other external device through a communication cable 58 (see FIG. 9), and based on commands and data received from the external device, and operations of switches in the display and operating unit 13, controls the transportation motor (not shown in the figure) that rotationally drives the platen 41 and tractor drive shaft 61, a carriage drive motor (not shown in the figure) that drives the carriage 42, and the print head 43 in order to print and convey the recording medium, and controls operation of the LEDs in the display and operating unit 13 according to the printing and paper feed operating states.

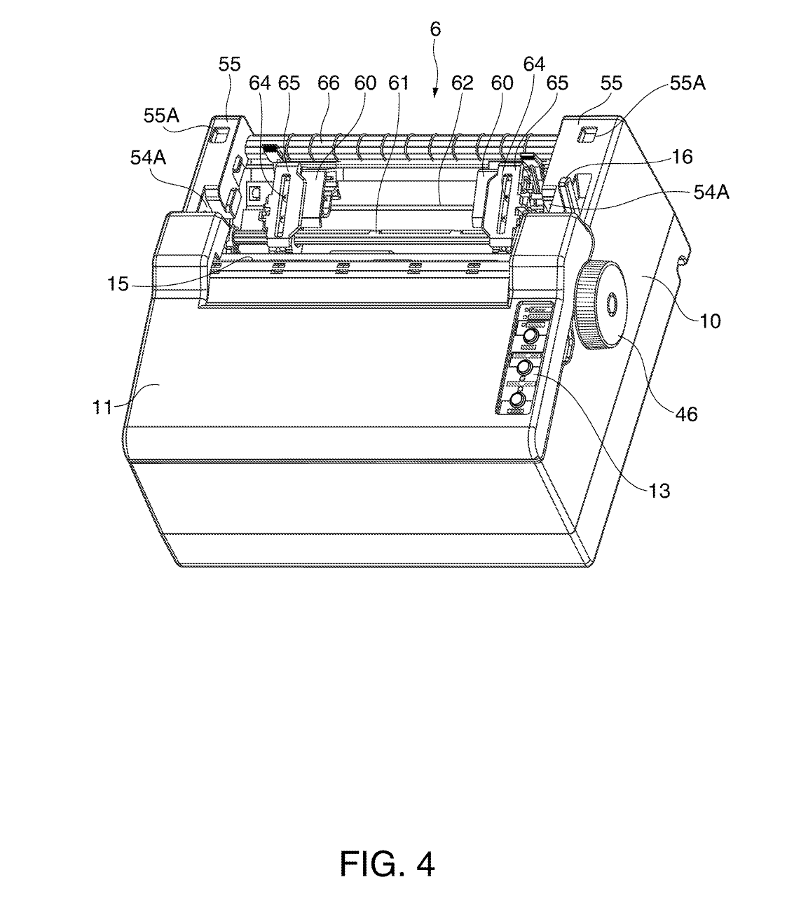

FIG. 4 is an external oblique view of the printer with the roll paper holder 2 removed.

As shown in FIG. 4 and FIG. 3, the fanfold paper supply unit 6 is disposed at the back of the printer assembly 4. The fanfold paper supply unit 6 includes a tractor drive shaft 61 and tractor guide shaft 62 spanning between the left and right side frames as described above, and a pair of left and right tractor units 60 that are fit onto these shafts 61 and 62 and can move widthwise to the printer 1, and is housed inside the main case 10 behind the printer assembly 4.

An endless belt 63 is wound around the tractor units 60, and when the tractor cover 65 is closed with plural pins 64 protruding from the belt fit into the marginal punch holes formed along the sides of the fanfold paper 120, the fanfold paper 120 is held between the pins 64 and the tractor cover 65. By then turning the tractor drive shaft 61 and driving the belt 63, the fanfold paper 120 is supplied to the printer assembly 4. A supply opening 67 from which the fanfold paper 120 enters is open at the back end of the fanfold paper supply unit 6, and a paper receiving member 66 that supports the fanfold paper 120 supplied from below is disposed at the bottom part of the supply opening 67.

As shown in FIG. 3, the roll paper holder 2 includes a holder case 20 that is disposed on top of the main case 10, a support shaft 24 that supports the paper roll 110, and a roll paper cover 21 (cover) that covers the paper roll 110 supported on the support shaft 24.

The paper roll 110 has a hollow core 111 as shown in FIG. 3, and the paper roll 110 is supported in the roll paper holder 2 by passing the support shaft 24 through this core 111. The core 111 may be sized so that the inside diameter of the core 111 is greatly larger than the outside diameter of the support shaft 24 as shown in FIG. 3, or so that the inside diameter of the core 111 and the outside diameter of the support shaft 24 are substantially equal, but in either case the paper roll 110 can be supported by the roll paper holder 2.

One end of the support shaft 24 passes through to the outside of the holder case 20, and a roll paper take-up knob 25 is attached to this end of the support shaft 24. The roll paper take-up knob 25 is exposed outside the roll paper holder 2, and can be turned manually. Turning this roll paper take-up knob 25 turns the paper roll 110, enabling taking up slack in the roll paper and taking up roll paper 112 that is returned from the printer assembly 4 as described below.

As indicated by the roll paper transportation path P1 in FIG. 3, the roll paper 112 is unwound from the bottom of the paper roll 110 stored in the roll paper holder 2 and is pulled into the paper entrance 48. A curved part 26 that is upwardly convex is disposed inside the roll paper holder 2 so that the roll paper 112 is first made to curve up, and the roll paper 112 curves over the curved part 26 to the paper entrance 48. A storage space 27 is formed inside the roll paper holder 2 above the space between the curved part 26 and paper entrance 48. This storage space 27 is a space for holding the reversed portion of the roll paper 112 when the roll paper 112 pulled from the paper entrance 48 into the printer assembly 4 is rewound.

In a printer 1 according to this embodiment of the invention, the roll paper 112 supplied by the roll paper holder 2 and the fanfold paper 120 supplied by the fanfold paper supply unit 6 can be selectively used as the recording medium for printing text or images by operating a paper feed selection switch 16 (see FIG. 4).

When the paper feed selection switch 16 shown in FIG. 4 is pulled forward, that is, towards the front of the printer 1, rotation of the platen 41 by the drive power from the transportation motor (not shown in the figure) is transmitted to the tractor drive shaft 61, the tractor drive shaft 61 thus rotates synchronously to the platen 41, the pressure roller 50 that presses the roll paper to the platen 41 is pushed down, and the pressure roller 50 separates from the platen 41. When the paper feed selection switch 16 is pushed to the back, the pressure roller 50 pushes against the platen 41 again, transfer of torque to the tractor drive shaft 61 is interrupted, only the platen 41 rotates, and the fanfold paper 120 is not conveyed by the fanfold paper supply unit 6. In this embodiment of the invention a movable spur gear that is part of a gear train mechanism (not shown in the figure) disposed to the right side frame 18 and is rotated and movably supported by the transportation motor (not shown in the figure) is moved by and made to engage or disengage a spur gear attached to the tractor drive shaft 61 as a result of operating the paper feed selection switch 16.

As shown in FIG. 3, the exit through which the roll paper 112 is supplied from the roll paper holder 2 to the printer assembly 4, and the exit through which the fanfold paper supply unit 6 supplies the fanfold paper 120 to the printer assembly 4, are both opposite the paper entrance 48 as shown in FIG. 3. As a result, there is no need to change the mechanism used for printing according to the type of recording medium because the same printer assembly 4 can be used with both roll paper 112 and fanfold paper 120.

When the recording medium is switched from the roll paper 112 to the fanfold paper 120 or from the fanfold paper 120 to the roll paper 112, the recording medium conveyed to the position of the print head 43 or beyond is conveyed in reverse and reverse fed toward the paper entrance 48.

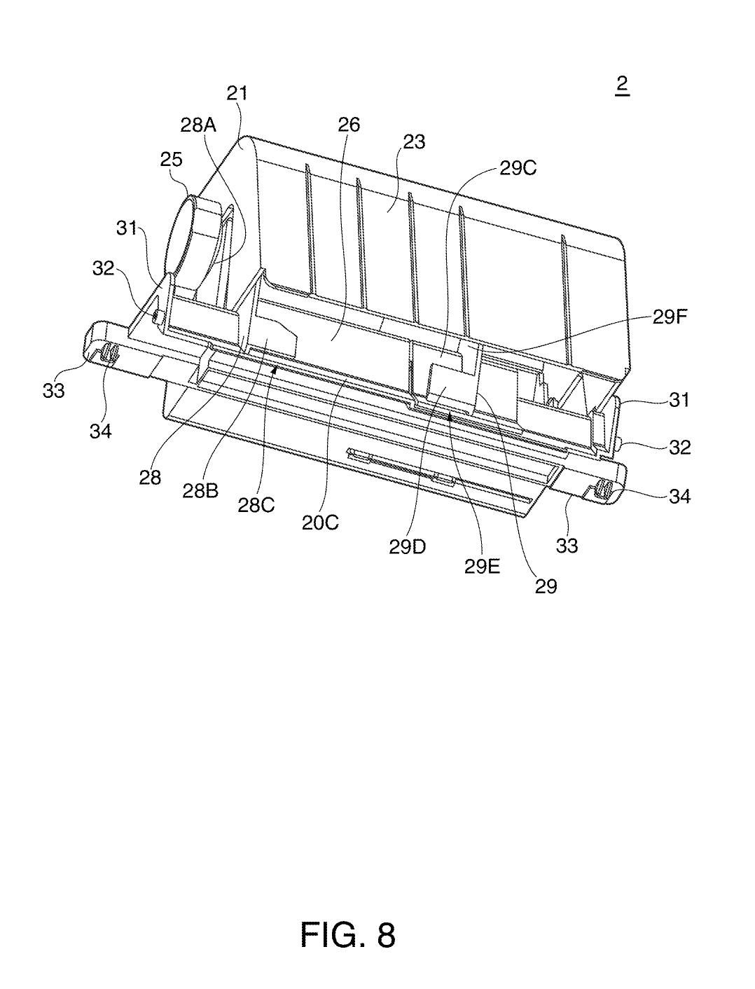

This reverse feed operation can be done by the control circuit board 57 controlling the transportation motor (not shown in the figure) to turn in reverse so that the platen 41 and tractor drive shaft 61 turn in reverse. More specifically, when a switch on the display and operating unit 13 is operated to reverse feed the recording medium, the control circuit board 57 causes the transportation motor to rotate a specific amount in reverse. If the roll paper 112 is being reversed, the leading end of the recording medium at the paper exit 14 or the position of the print head 43 is returned to the position of the pressure roller 50 by the platen 41 rotating in reverse. The roll paper take-up knob 25 is then turned to take up the roll paper 112 pulled into the storage space 27 onto the paper roll 110, and the leading end of the roll paper 112 is positioned to the inside of the roll paper holder 2 from the roll paper exit 20C (FIG. 8) so as to not interfere with transportation of the fanfold paper 120.

The fanfold paper 120 can be reversed by driving the platen 41 and tractor drive shaft 61 in reverse. After the leading end of the fanfold paper 120 is detected by the paper detector 53, the fanfold paper 120 is reversed only a specific distance towards the tractor units 60 to a position where the fanfold paper 120 will not interfere with the roll paper 112. When the fanfold paper 120 is stopped at this position, the fanfold paper 120 is held loaded in the tractor units 60. As a result, the fanfold paper 120 can be conveyed toward the platen 41 by simply driving the tractor drive shaft 61 when using the fanfold paper 120 is desired again, and there is no need to set the fanfold paper 120 in the tractor units 60 again. Note that the fanfold paper 120 can be removed from the fanfold paper supply unit 6 if desired by driving the tractor drive shaft 61 in reverse.

The recording medium can also be reversed by manually turning the paper feed knob 46 in reverse while the printer 1 is stopped. In this situation the leading end of the recording medium is returned to a position just before the pressure roller 50. The recording medium returned to before the pressure roller 50 can be pulled back manually, and if the roll paper 112 was reversed, the roll paper take-up knob 25 of the roll paper holder 2 can be turned to rotate the paper roll 110 and take up the roll paper 112. By reversing the transportation motor (not shown in the figure) of the printer 1 or operating the paper feed knob 46, the tractor drive shaft 61 of the fanfold paper supply unit 6 turns in reverse in conjunction with the platen 41. As a result, when the fanfold paper 120 is reversed, the fanfold paper 120 can be turned to the position of the tractor units 60 by reverse rotation of the tractor drive shaft 61.

By thus returning at least one of the roll paper 112 and fanfold paper 120 at least to a position before the paper entrance 48, the other recording medium can be fed from the paper entrance 48 to the printer assembly 4 for printing. As a result, a simple operation enables using both roll paper 112 and fanfold paper 120 with the printer 1.

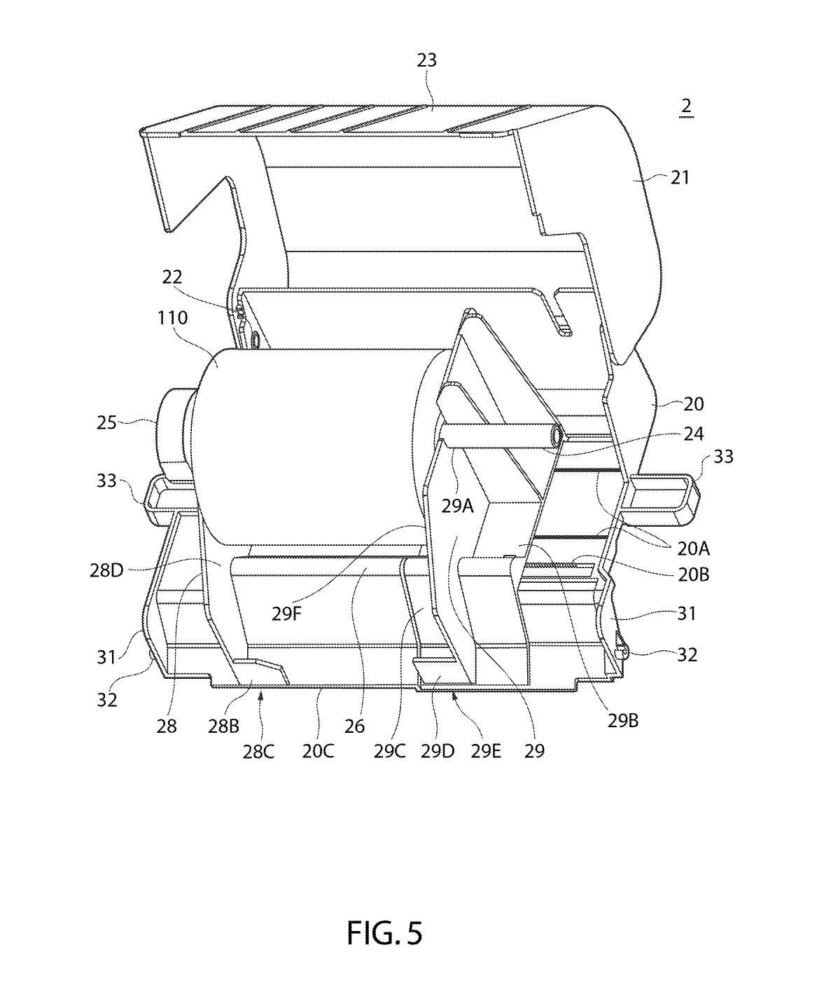

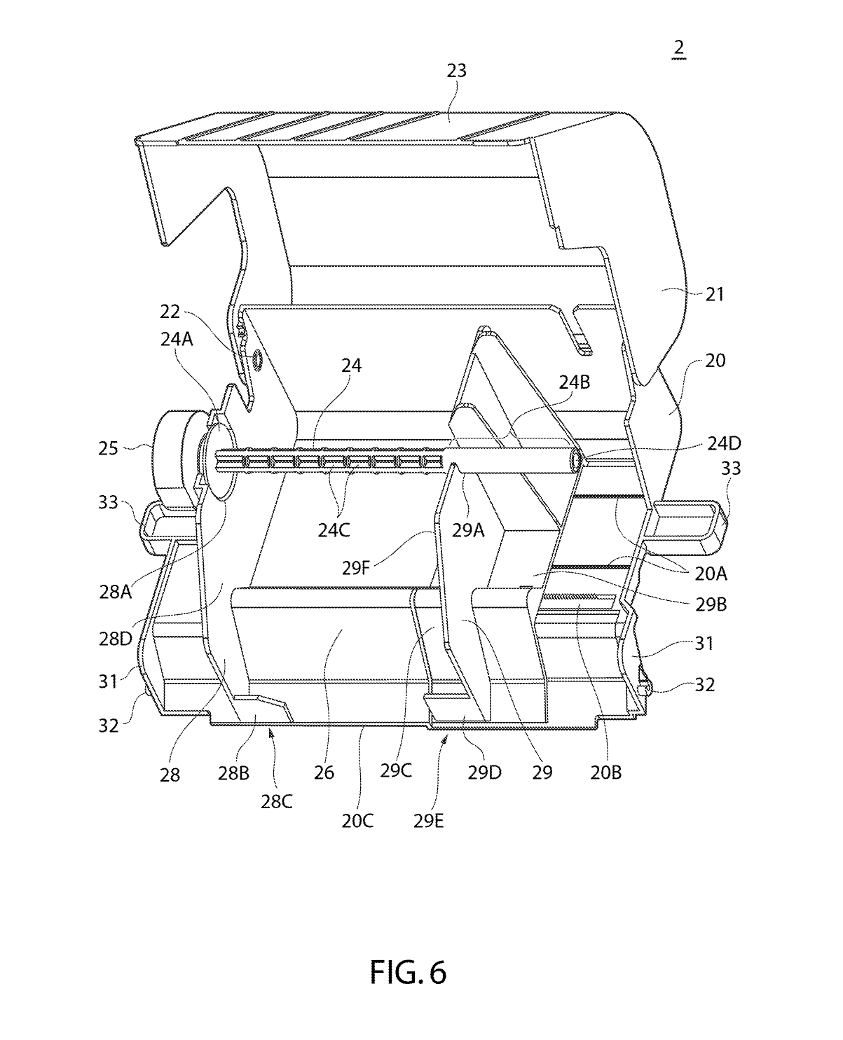

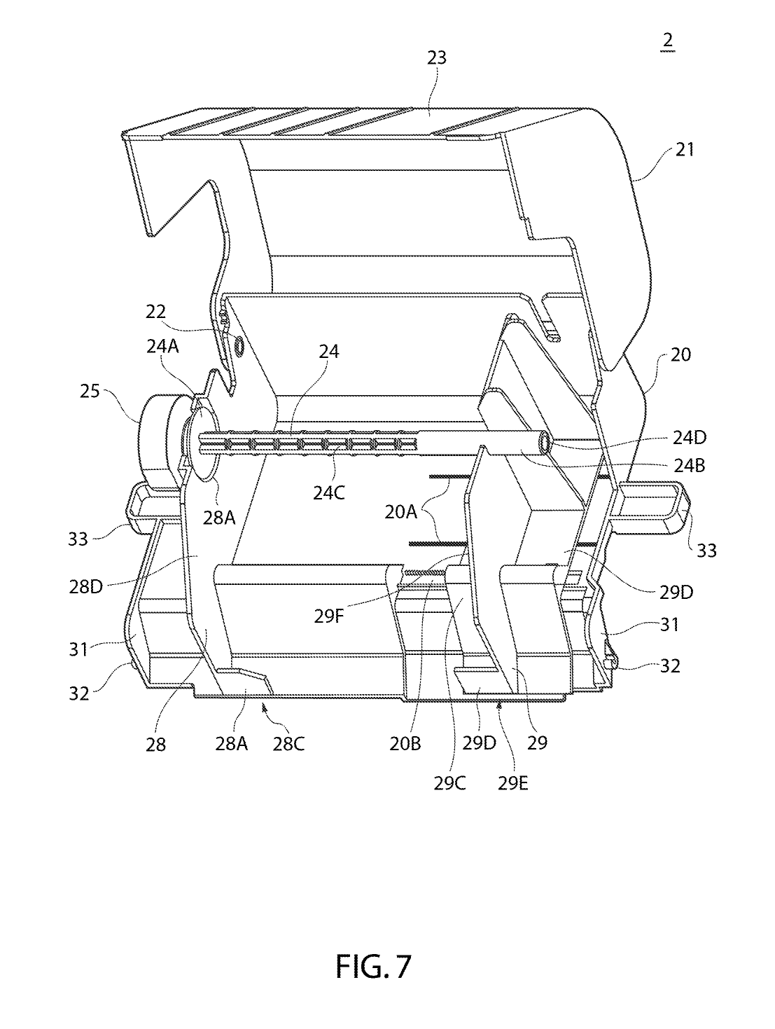

FIG. 5 is an oblique view of the roll paper holder 2 with paper roll 110 stored thereinside. FIG. 6 and FIG. 7 are oblique views of the same with the paper roll 110 removed. FIG. 8 is an oblique view of the roll paper holder 2 from below.

As shown in the figures, the roll paper holder 2 has a fixed guide panel 28 disposed vertically to the bottom of the holder case 20, and a movable guide panel 29 vertically disposed opposite the fixed guide panel 28. The paper roll 110 is stored between the fixed guide panel 28 and movable guide panel 29.

The fixed guide panel 28 is a flat panel affixed to the left side of the roll paper holder 2, and the guide surface 28D on one side contacts the paper roll 110 and the side of the roll paper 112 delivered from the paper roll 110.

The movable guide panel 29 has a guide surface 29F (FIG. 8), which is a flat surface that contacts the paper roll 110 and the side edge of the roll paper 112 delivered from the paper roll 110, and can be moved and adjusted to the width of the paper roll 110. For printing, the guide surface 28D of the fixed guide panel 28 and the guide surface 29F of the movable guide panel 29 are adjusted to contact or nearly contact both sides of the paper roll 110. FIG. 6 shows the movable guide panel 29 moved towards the fixed guide panel 28 side, and FIG. 7 shows the movable guide panel 29 separated from the fixed guide panel 28.

The roll paper holder 2 guides the ends of the paper roll 110 and the roll paper 112 pulled from the paper roll 110 by means of the guide surface 28D and guide surface 29F. Sideways movement of the sides of the roll paper 112 when the roll paper 112 is pulled out and returned is thereby restricted, and travel of the roll paper 112 in a straight line can be improved.

It should be noted that the guide surface 28D of the fixed guide panel 28 and the guide surface 29F of the movable guide panel 29 are not limited to completely flat surfaces. More specifically, all of the parts including the part that contacts the sides of the paper roll 110 and the part that guides the roll paper 112 to the roll paper exit 20C need not be flat and may have recesses insofar as the configuration enables contacting the side edges of the roll paper 112 and guiding the roll paper 112. The location, shape, and size of such recesses can be desirably configured insofar as the recess will not catch the roll paper 112 or cause the roll paper 112 to become skewed. In addition, a recess located at a position that contacts the roll paper 112 can be configured to prevent the roll paper 112 from catching on the recessed part by rendering a smooth bevel or curved surface on the edges of the recessed part.

One end of the support shaft 24 is connected to the roll paper take-up knob 25 located outside the holder case 20 as described above, and a large diameter support disk 24A is formed on the support shaft 24 near the roll paper take-up knob 25. The diameter of the support disk 24A is greater than other parts of the support shaft 24. A large diameter bearing unit 28A corresponding to the diameter of the support disk 24A is formed in the fixed guide panel 28 on the left side of the roll paper holder 2, and the support disk 24A is fit in the bearing unit 28A. This configuration of supporting the support disk 24A, which is larger in diameter than the other parts of the support shaft 24, by means of this bearing unit 28A increases friction between the outside surface of the support disk 24A and the bearing unit 28A, and thus applies greater resistance to support shaft 24 rotation. When the roll paper 112 is pulled toward the printer assembly 4, this resistance prevents slack in the roll paper 112 resulting from the paper roll 110 rolling freely and the roll paper 112 unwinding excessively.

The movable guide panel 29 that supports the other end of the support shaft 24 rises substantially perpendicularly to the bottom of the holder case 20, and has a flat part 29B at its base that overlaps the bottom of the holder case 20. The movable guide panel 29 is located on the right side of the roll paper holder 2, can slide in the axial direction of the support shaft 24, and can be stopped at any desirable position to which it is moved.

More specifically, the movable guide panel 29 can slide left and right within a specific range widthwise to the holder case 20, and ribs 20A and a rack 20B (engaging member) with numerous teeth rendered on the bottom of the holder case 20 extend in the sliding direction throughout the sliding range of the movable guide panel 29. Channels (not shown in the figure) that engage the ribs 20A, and an engaging part (not shown in the figure) on which teeth that mesh with the teeth of the rack 20B are formed, are formed on the back of the flat part 29B of the movable guide panel 29. By lifting the flat part 29B so that this engaging part disengages the rack 20B, the movable guide panel 29 can be slid freely along the axial direction of the support shaft 24. By engaging this engaging part on the back of the flat part 29B with the teeth of the rack 20B, movement of the movable guide panel 29 can be restricted and the movable guide panel 29 can be fixed in the desired position.

Except for the support disk 24A, the support shaft 24 has a uniform diameter enabling the support shaft 24 to be passed through the core 111 of the paper roll 110, and is fit into and supported by a bearing part 29A formed in the movable guide panel 29. The portion of the support shaft 24 that contacts the bearing part 29A throughout the full range of movable guide panel 29 movement is a cylindrical portion 24B of which the entire circumference is a smooth curved surface, thereby reducing resistance to sliding the movable guide panel 29. Voids 24C are formed in the portion of the support shaft 24 not including the cylindrical portion 24B, that is, the portion that does not contact the bearing part 29A, and the axial center of the cylindrical portion 24B is hollowed out to form a hole 24D, thereby reducing weight and saving material. In addition, forming the voids 24C makes the surface of the support shaft 24 rough and thereby limits sliding between the support shaft 24 and the core 111. As a result, slack caused by unnecessary rotation of the paper roll 110 can be prevented and the paper roll 110 can be prevented from rolling freely when the roll paper take-up knob 25 is turned.

As described above, a curved part 26 is disposed to the holder case 20 to make the roll paper 112 curve as described above, and a curved part 29C is disposed to the movable guide panel 29 to join the curved part 26. The curved part 26 and curved part 29C can therefore be positioned to the widthwise edges of the roll paper 112 and the roll paper 112 can reliably be made to curve.

Furthermore, because the curved part 26 is formed in unison with the base part of the fixed guide panel 28, and the curved part 29C is formed in unison with the base part of the movable guide panel 29, the roll paper 112 will not enter between the fixed guide panel 28 and curved part 26, or between the base of the movable guide panel 29 and the curved part 29C. The roll paper 112 can therefore be reliably made to curve without the roll paper 112 folding or curling.

A front panel part 28B is formed at the front end of the fixed guide panel 28, and a slotted opening 28C is formed at the bottom end of the front panel part 28B. A front panel part 29D is also formed at the front end of the movable guide panel 29, and a slotted opening 29E is formed at the bottom end of the front panel part 29D. As shown in detail in FIG. 8, one end of the opening 28C is closed by the fixed guide panel 28 and the other end is open. One end of the opening 29E is closed by the movable guide panel 29 and the other end, that is, the end on the fixed guide panel 28 side, is open. This opening 28C and opening 29E communicate with each other, and render a roll paper exit 20C that is substantially the same width as the width of the roll paper 112.

The roll paper 112 is fed from the roll paper holder 2 to the printer assembly 4 through opening 28C and opening 29E, and at least the side edges of the roll paper 112 are prevented from moving up and down by the opening 28C and opening 29E. As a result, after travelling around the curved part 26 and curved part 29C, the roll paper 112 is guided down to pass through the openings 28C and 29E of the roll paper exit 20C and curve to the paper entrance 48 as shown in FIG. 3.

The roll paper cover 21 of the roll paper holder 2 is pivotably attached to the holder case 20 by a hinge 22 and can open upwards to the back of the printer 1, thereby exposing the paper roll 110 when the roll paper cover 21 is open and enabling the paper roll 110 to be loaded or removed. When the roll paper cover 21 is closed, the paper roll 110 is covered by the roll paper cover 21 and the distal end of the roll paper cover 21 is inside the paper exit 14 as shown in FIG. 3, thereby protecting the paper roll 110 from dust and soiling.

FIG. 9 is a partially cut-away section view showing the roll paper holder 2 when installed.

The mounting structure of the roll paper holder 2 to the printer 1 is described next with reference to FIG. 9 and FIG. 4 to FIG. 8.

As shown in FIG. 5 to FIG. 8, substantially cylindrical engaging claws 32 are formed protruding to the side from the front side surfaces 31 of the holder case 20.

As shown in FIG. 4, a pair of left and right engaging channel openings 54A are formed at the back of the printer assembly 4 on top of the main case 10. The engaging channel openings 54A are formed on both sides at the end part of the main case 10, and the front side surfaces 31 of the roll paper holder 2 can be inserted to these engaging channel openings 54A.

As shown in FIG. 9, an engaging channel 54 is formed sloping forward and down at a position below the engaging channel opening 54A in the right side frame 18 of the printer assembly 4. When the front side surface 31 is inserted from the engaging channel opening 54A, the engaging claw 32 enters the engaging channel 54, and the load at the front of the roll paper holder 2 is supported by the bottom of the engaging channel 54 through the intervening engaging claw 32.

In addition, while not shown in the figures, a similar engaging channel 54 is also formed below the engaging channel opening 54A in the left side frame 19 of the main case 10, and the load of the roll paper holder 2 is supported by the engaging claw 32 in the engaging channel 54.

The roll paper holder 2 is thus supported on the printer assembly 4 at the front part of the roll paper holder 2 as a result of the pair of left and right engaging claws 32 being engaged with the engaging channels 54 disposed to the side frames 18 and 19.

As shown in FIG. 4, a flat surface 55 positioned above the fanfold paper supply unit 6 is disposed on both sides at the back end of the main case 10, and a recess 55A is formed in each of these flat surfaces 55.

A pair of left and right corresponding feet 33 (rear feet) are formed protruding widthwise at the back of the holder case 20 as shown in FIG. 5 to FIG. 8. These feet 33 rest on the pair of flat surfaces 55 disposed to the main case 10.

An engaging claw 34 is rendered projecting down from the bottom surfaces of the pair of feet 33 disposed on the left and right sides of the roll paper holder 2 as shown in FIG. 8 and FIG. 9, and these engaging claws 34 fit into the matching left and right recesses 55A when the roll paper holder 2 is placed on the flat surfaces 55. The engaging claws 34 are formed with the back going to a point, and are positioned with the back in contact with the back ends of the recesses 55A. An elastomer pad 35 is affixed on the bottom of the feet 33 behind the engaging claws 34, and these elastomer pads 35 contact the flat surfaces 55.

The load of the roll paper holder 2 is thus supported at the back of the roll paper holder 2 by the feet 33 contacting the flat surfaces 55. In addition, because the engaging claws 34 disposed on the bottom of the feet 33 fit into the recesses 55A and limit horizontal movement of the roll paper holder 2, the roll paper holder 2 is firmly supported so that it will not move during printer 1 operation.

Furthermore, because the elastomer pads 35 disposed to the bottom of the feet 33 contact the flat surfaces 55, marring the surface of the flat surfaces 55 can be prevented, horizontal movement of the roll paper holder 2 can be firmly limited because the coefficient of friction of the elastomer pads 35 is high, slack in the roll paper 112 can be prevented because the elastomer pads 35 absorb vibration during printer 1 operation, and other beneficial effects can be achieved.

Furthermore, because the hinge 22 of the roll paper holder 2 is located behind the feet 33, when the roll paper holder 2 is set on the main case 10 as shown in FIG. 9 and the roll paper cover 21 is opened, the center of gravity of the roll paper cover 21 moves to the back, and a clockwise moment centered on the feet 33 as seen in the figure results. This moment is transferred from the engaging claws 32 to the top edge 54B of the engaging channel 54, but because the engaging channel 54 is formed as a channel that slopes forward and down in this embodiment of the invention, the edge 54B of the engaging channel 54 is substantially perpendicular to this moment. More specifically, because the edge 54B is shaped to function as a bearing surface that bears this moment, the engaging claws 32 will not escape from the engaging channels 54 when this moment is applied. As a result, the roll paper holder 2 is stably supported even when the roll paper holder 2 is set on the main case 10 and the roll paper cover 21 opens and closes.

Furthermore, as shown in FIG. 9, because the support shaft 24 of the roll paper holder 2 is positioned in front of the feet 33, the load of the paper roll 110 is also in front of the feet 33. As a result, because the load of the paper roll 110 is dispersed and supported from below by the flat surfaces 55 and engaging channels 54, the load of the paper roll 110 does not produce a clockwise moment on the engaging channel 54 as seen in the figure. The paper roll 110 can therefore be supported stably, concentration of the load of the paper roll 110 on the engaging channels 54 can be prevented, and durability can be improved because a moment in the same direction as the moment produced by opening the roll paper cover 21 is not applied to the engaging channels 54 due to the load of the paper roll 110.

The roll paper holder 2 can be removably installed to the main case 10 of a printer 1 according to this embodiment of the invention, and the printer 1 can also print when the roll paper holder 2 is not installed.

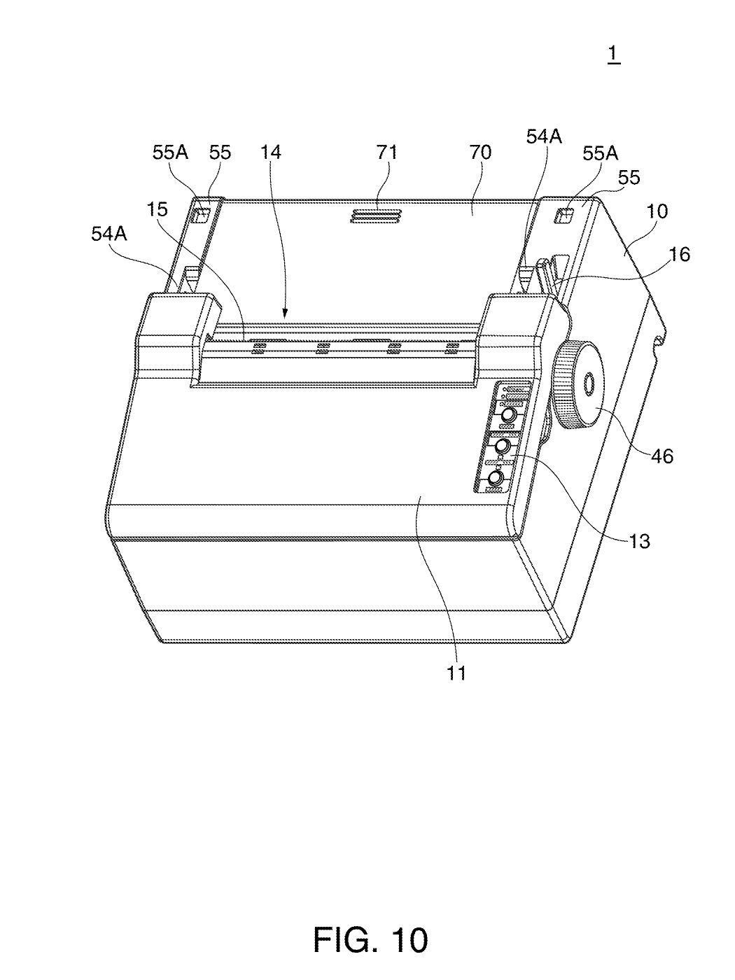

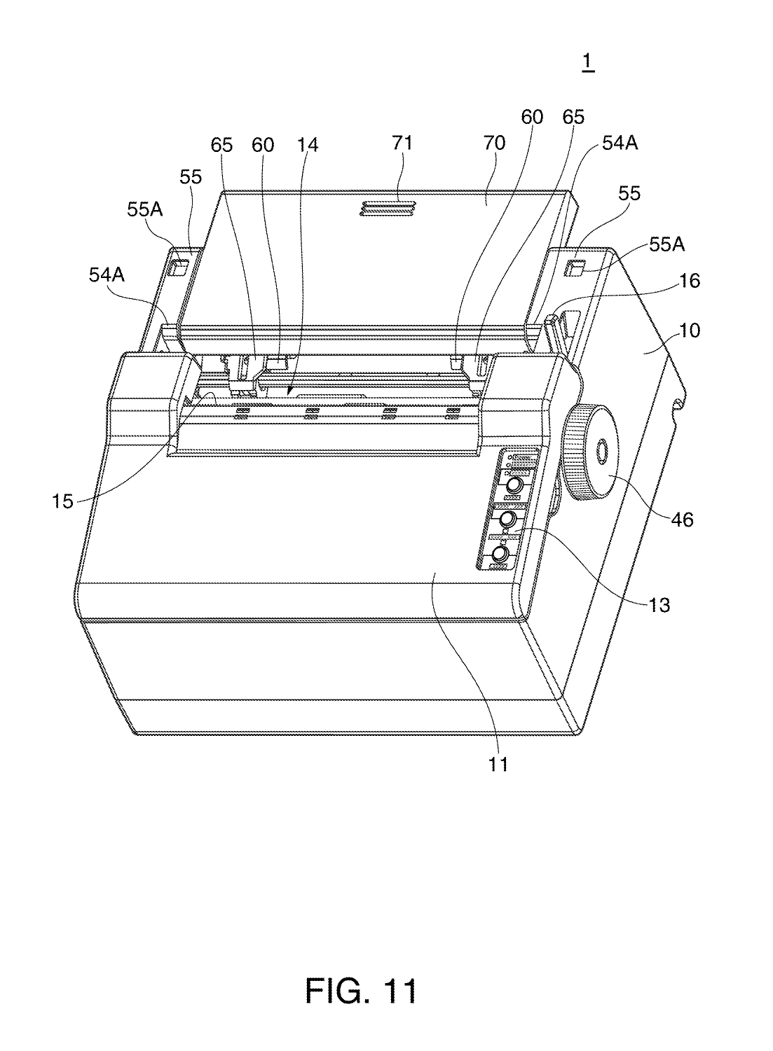

FIG. 10 is an oblique view of the printer 1 when the roll paper holder 2 is removed and a separator 70 is installed. FIG. 11 and FIG. 12 are oblique views of the printer 1 when the separator 70 has been slid open, FIG. 11 being an oblique view from the front and FIG. 12 being an oblique view from the back.

As shown in FIG. 10, the separator 70 is attached to the main case 10 so that the top of the fanfold paper supply unit 6 is covered. As shown in FIG. 4, the fanfold paper supply unit 6 is exposed from the opening formed in the main case 10 when the roll paper holder 2 is not installed, and the separator 70 is a cover that covers this opening in the main case 10.

When the roll paper holder 2 is not installed, the printer 1 prints using fanfold paper 120 as the recording medium. In this configuration there is no discharge guide 23 because the roll paper holder 2 is not installed, and the fanfold paper 120 discharged from the paper exit 14 is fed over the top of the separator 70 to the back of the printer 1. The fanfold paper 120 is also supplied from outside the printer 1 to the supply opening 67 at the back of the printer 1, and this fanfold paper 120 is conveyed passing below the separator 70 by the fanfold paper supply unit 6. As a result, when the roll paper holder 2 is removed, the fanfold paper 120 supplied to the printer 1 is separated from the fanfold paper 120 discharged from the printer 1 by the separator 70, and fanfold paper 120 jams can be prevented.

A finger catch 71 is disposed in the top surface of the separator 70, and the separator 70 can be slid back by manually pulling on this finger catch 71.

In FIG. 10 the separator 70 is positioned all the way forward, and in FIG. 11 and FIG. 12 the separator 70 is positioned all the way to the back.

When positioned as shown in FIG. 11 and FIG. 12, there is a gap between the separator 70 and the paper exit 14. The paper entrance 48 is exposed from this gap as shown in FIG. 12, and recording media can be inserted from above into the printer assembly 4. The engaging channel openings 54A are also exposed at both sides of this gap, and the engaging claws 32 (FIG. 8) of the roll paper holder 2 can be inserted to the engaging channels 54 formed in the side frames 18 and 19. The recesses 55A formed in the flat surfaces 55 of the main case 10 are also exposed. Therefore, by sliding the separator 70 to the back as shown in FIG. 11 and FIG. 12, the roll paper holder 2 can be installed to the top of the main case 10 while the separator 70 remains installed. When both the separator 70 and the roll paper holder 2 are installed to the main case 10, roll paper 112 can be supplied from the paper roll 110 stored in the roll paper holder 2, fanfold paper 120 can be supplied from the back of the printer 1, and the printer 1 can print on both roll paper 112 and fanfold paper 120.

The separator 70 is held both at the position shown in FIG. 10 and the position shown in FIG. 11 and FIG. 12 so that it will not separate from the main case 10, and can be removed from the main case 10 by sliding the separator 70 to an intermediate position. As a result, the separator 70 can be easily installed and removed, and accidental separation of the separator 70 can be prevented whenever printing is enabled, that is, both when the roll paper holder 2 is not installed and when the roll paper holder 2 is installed.

As described above, in a printer 1 according to the embodiment of the invention described above the roll paper holder 2 is connected to the printer assembly 4 by engaging engaging claws 32 in engaging channels 54 rendered in the side frames 18 and 19, and the fanfold paper supply unit 6 is connected to the printer assembly 4 by means of a tractor drive shaft 61 and tractor guide shaft 62 spanning the side frames 18 and 19 and thereby rendered in unison with the printer 1.

This printer 1 has a printer assembly 4 including a print head 43; a fanfold paper supply unit 6; and a roll paper holder 2. The fanfold paper supply unit 6 includes an upper paper guide 45 and a lower paper guide 47 that form at least part of the paper feed path guiding the recording medium to the print head 43 side, and tractor units 60 that supply a web of sheet paper in the form of fanfold paper 120 with marginal punch holes to the paper feed path. The roll paper holder 2 supports the roll paper 112 that is wound into a paper roll 110 and conveyed through the paper feed path. Because the roll paper holder 2 is positioned above the fanfold paper supply unit 6, which is located at the back side of the printer assembly 4, a compact printer 1 that can use both fanfold paper 120 and roll paper 112 and has a small footprint can be provided.

Furthermore, because the roll paper exit 20C of the roll paper holder 2 is disposed opposite the paper entrance 48 and movement of the roll paper 112 in the thickness direction is limited to a specific range at this roll paper exit 20C, the roll paper 112 wound in a roll can be smoothly guided to the paper entrance 48 of the printer assembly 4 and can be conveyed inside the printer assembly 4. As a result, the roll paper 112 can be conveyed stably. In addition, because the exit of the fanfold paper supply unit 6 is also opposite the paper entrance 48, the configuration from the paper entrance 48 to the printer assembly 4 can be used with two types of recording media, roll paper 112 and fanfold paper 120. As a result, the size and the cost of the printer 1 can be further reduced because there is no need to change the configuration of the printer assembly 4 according to the type of recording medium.

The roll paper holder 2 has guide surfaces 28D and 29F that guide the side edges of the roll paper 112 delivered from the paper roll 110, the sides of the roll paper exit 20C are rendered by a pair of slotted openings 28C and 29E that restrict sideways movement of the roll paper 112, and the sides of the roll paper 112 contact the guide surfaces 28D and 20F from the paper roll 110 to the openings 28C and 29E of the roll paper exit 20C. As a result, because the roll paper 112 is guided by the guide surfaces 28D and to the exit of the roll paper holder 2 and pass through the slotted openings 28C and 29E to the paper entrance 48, the roll paper 112 wound in a roll can be conveyed more stably in a straight line.

Furthermore, because engaging claws 32 are disposed to the front of the roll paper holder 2, these engaging claws 32 are engaged in engaging channels 54 that open to the back of the printer assembly 4, and the rear feet of the roll paper holder 2 are set on the flat surfaces 55 of the main case 10 that houses the printer assembly 4, the roll paper holder 2 is supported without shifting horizontally as a result of the engaging claws 32 engaging engaging channels 54 disposed at the back of the printer assembly 4. In addition, the load of the roll paper holder 2 is supported by the main case 10 because the roll paper holder 2 rests on the flat surfaces 55 of the main case 10 housing the printer assembly 4. As a result, the roll paper 112 can be stably supported so that the roll paper 112 does not interfere with the supply path of the fanfold paper 120, and both roll paper 112 and fanfold paper 120 can be guided to the paper entrance 48.

Furthermore, because the engaging claws 34 formed on the bottom of the feet 33 of the roll paper holder 2 fit into recesses 55A formed in the flat surfaces 55, horizontal movement of the roll paper holder 2 is firmly limited.

In addition, because the roll paper holder 2 has a roll paper cover 21 that covers the paper roll 110, soiling the paper roll 110 can be prevented. In addition, while a clockwise moment is produced on the engaging claws 32 when the roll paper cover 21 opens, the roll paper holder 2 can be stably supported when the roll paper cover 21 opens and closes because the engaging channels 54 have an edge 54B that functions as a bearing surface to receive this moment.

The invention is described with reference to a preferred embodiment thereof above, but the invention is not so limited. For example, a dot matrix printer that forms dots on the recording medium by driving wires to protrude is used by way of example in the embodiment described above, but the invention is not so limited and the invention can also be applied to thermal printers that record text and images by applying heat to the recording medium using a thermal line head, to inkjet printers that record by discharging ink onto the recording medium, and to laser printers.

In addition, the roll paper 112 and fanfold paper 120 are not particularly limited insofar as they are compatible with the recording method of the printer, and may be plain paper or multipart form paper in a dot matrix printer, monochrome or color thermal paper in a thermal paper, and plain paper or coated paper in an inkjet printer. Sheets or webs of film and other synthetic media can also be used instead of paper.

A configuration in which engaging claws 32 disposed to the front end of the roll paper holder 2 are inserted down into and engaged in the engaging channels 54 from engaging channel openings 54A is described in the foregoing embodiment, but the invention is not so limited. For example, the same effect as described above can be achieved with a configuration in which engaging claws are inserted from the back of the printer assembly 4 to and engaged with engaging channels that extend horizontally to the front, and with a configuration in which the engaging channels 54 bend in the middle.

The engaging claws 32 in the foregoing embodiment are cylindrically shaped, and the engaging claws 34 are shaped with a point, but the invention is not so limited. For example, the ends of the engaging claws 32 and 34 may be hook-shaped, and a configuration in which a large diameter part is disposed to the distal end of the engaging claws 32 to inhibit separation from the engaging channels 54 is also conceivable.

Yet further, a protruding part may be disposed protruding from the side of the printer assembly 4, and a channel that engages this protruding part may be disposed to the roll paper holder 2 side.

Yet further, the materials from which the parts of the printer assembly 4, the main case 10, and the holder case 20 and roll paper cover 21 of the roll paper holder 2 are made are not limited. For example, a partially transparent material may be used so that how much paper roll 110 remains in the roll paper holder 2 can be checked visually by looking through a transparent member. Further alternatively, the joint between the roll paper cover 21 and holder case 20 may be sealed, and other detailed aspects of the printer 1 configuration can be changed as desired without departing from the scope of the accompanying claims.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. A recording device comprising:
a recording device assembly including a recording head;
a sheet guide that forms at least part of a transportation path that guides a recording medium to the recording head side;
a continuous sheet media supply unit including a tractor unit that supplies a first recording medium of continuous sheets with marginal punch holes to the transportation path; and
a roll media support unit that supports a rolled recording medium, which is a second recording medium that is wound in a roll and is conveyed through the transportation path,
the roll media support unit disposed above the continuous sheet media supply unit disposed at the back side of the recording device assembly.

2. The recording device described in claim 1, wherein:
the roll media support unit has an exit unit that limits movement of the second recording medium in the thickness direction to a specific range, and is opposite an entrance to the transportation path when the roll media support unit is installed to the recording device assembly.

3. The recording device described in claim 1, wherein:
the roll media support unit has a guide surface that guides a side edge of the second recording medium supplied from the rolled recording medium;
the side ends of the exit unit are rendered by a pair of slotted openings that limit sideways movement of the second recording medium; and
the side edge of the second recording medium contacts the guide surface from the rolled recording medium to the opening of the exit unit.

4. The recording device described in claim 1, wherein:
an engaging claw is disposed to the front part of the roll media support unit;
the engaging claw is engaged in an engaging channel that opens to the back of the recording device assembly; and
rear feet of the roll media support unit are placed on a flat surface of the main case that houses the recording device assembly.

5. The recording device described in claim 4, wherein:
the roll media support unit includes a support shaft that supports the second recording medium, and a cover that covers the second recording medium and can open to the back; and
a bearing surface that receives a moment that is produced when the cover opens to the back is rendered on the engaging channel that opens to the back of the recording device assembly.

6. The recording device described in claim 5, wherein:
the support shaft of the roll media support unit is located in front of the rear feet.

7. A recording medium supply mechanism of a recording device that has a recording head, comprising:
a continuous sheet media supply unit including a tractor unit that supplies a first recording medium of continuous sheets with marginal punch holes to a transportation path that guides a recording medium to the recording head side; and
a roll media support unit that supports a rolled recording medium, which is a second recording medium that is wound in a roll and is conveyed through the transportation path, and is removably installed to the recording device assembly,
the roll media support unit being disposed above the continuous sheet media supply unit disposed at the back side of the recording device assembly.
